(19) United States
(12) Patent Application Publication
(10) Pub. No.: US 2010/0213006 A1
(43) Pub. Date: Aug. 26, 2010

(54) Escape System for Emergency Evacuation

(75) Inventors: Thyge Baungaard, Esbjerg (DK); Jens Nielsen, Arre (DK)

Correspondence Address: VEDDER PRICE P.C., 222 N. LASALLE STREET, CHICAGO, IL, 60601, US

(73) Assignee: VIKING LIFE-SAVING EQUIPMENT A/S, Esbjerg V (DK)

(21) Appl. No.: 12/303,699

(22) PCT Filed: Jun. 12, 2007
(86) PCT No.: PCT/DK07/00284

§ 371 Date: May 7, 2010

(30) Foreign Application Priority Data
Jun. 13, 2006 (DK) PA 2006 00799

(51) Int. Cl. A62B 1/20

(52) U.S. Cl. 182/48

(57) ABSTRACT

The invention relates to an improved escape system including a chute adapted to compensate for varying vertical distance. Elastic cords extend in a course of direction which progresses differently from vertically when the escape system has been launched and the chute is hanging vertically from the higher position to the lower position, such that tension is applied to the elastic cords. By the present invention it is realised that a longer elongation of the chute may be obtained without increasing the minimum length when the elastic cords extend in such a course of direction, because the cords hereby become longer than in a course of direction progressing straight and vertically. Since any elastic cord has a maximum strain which it may safely endure, a longer extent of such a cord subjected to maximum strain will result in a longer elongation, and hence longer maximum length while maintaining or even reducing the minimum length. One effect is therefore that the ability of the escape system to compensate for varying evacuation height is improved.

### FIELD OF THE INVENTION

The present invention relates to an escape system for emergency evacuation from a first higher position to a second lower position, where the escape system includes a chute adapted to compensate for varying vertical distance between said first higher and said second lower positions.

### BACKGROUND OF THE INVENTION

Various solutions have been presented in the past for evacuating people from buildings, airplanes, ships and oil rigs. When the height is given and constant, one set of conditions are given, but when the height varies the problems become more difficult. Varying height is especially present under maritime emergency conditions, e.g. due to high waves and/or because a ship has a list, i.e. is tilting to one side because of a displaced cargo or due to a hole in one side where water is flooding in. Maritime emergencies often happen during stormy weather which is a factor that increases the problem of varying height. In one known solution there is a slide which extends from the high evacuation point and downwards in a 30-45 degree angle away from the ship to the sea.

The company VIKING LIFE-SAVING EQUIPMENT of Esbjerg, Denmark, has marketed maritime systems adapted for evacuation where most of the descent is practically vertical. Such systems comprise a chute having a succession of linked, rigid and spaced apart steel rings which are connected by elastic cords attached to the rings. The elastic cords and rings are arranged to allow longitudinal stretching as well as contraction. The chute also has an elastic stocking-like device arranged and held inside the succession of rings. The stocking-like device is adapted to slow a rate of descent of a falling person who is being evacuated through the stocking-like device. Each elastic cord extends vertically from the top to the bottom of the chute when the chute is in use and is launched from a high evacuation position and allowed to extend freely downwards. The long elastic cords are attached to each ring with a bracket and extend in parallel, vertical courses of direction, each being parallel to a longitudinal axis of the chute. Normally the lower end of the chute is anchored at a floating platform or life raft. Due to the elastic cords, the chute is able to stretch as well as contract to compensate for varying height caused by waves. This allows people to escape through the chute even when the length of the chute changes.

Escape or rescue devices are also known from WO 84/02658 and U.S. Pat. No. 3,973,644. WO 84/02658 discloses a stocking-like escape device comprising a stocking of canvas material or similar material. The stocking, which is made of netting permitting the passage of wind, is with axial intervals provided with an annular reinforcing element for stretching out the stocking. The stocking is connected to two or more axially extending lines which are connected to the reinforcing elements and to each reinforcing element on diametrically opposite sides thereof. However, since rigid lines are used to connect the reinforcing elements, such a device is unsuitable for use where the vertical escape height is varying. U.S. Pat. No. 3,973,644 discloses a rescue apparatus for enabling persons to escape safely from burning buildings, for instance, and comprises a flexible tubular device which is elastic only in the transverse and circumferential direction to slow the rate of descent of a body falling through the tubular device, various means being provided for fixing the open upper end of the tubular device to the elevated point when the person is to be rescued through the lower open end of the device. Furthermore, such an apparatus is unsuitable for compensating for varying height.

Over the years it seems that storms are becoming harsher. Also, ships and liners are becoming larger and larger. This combination calls for an improvement of escape systems in order to increase safety in such conditions.

### SUMMARY

It is an object of the present invention to provide an escape system which allows substantially vertical evacuation and which provide improved compensation for varying evacuation height. Other objects appear from the description and the appended figures.

One aspect of the invention involves an escape system for emergency evacuation from a first higher position to a second lower position, where the escape system includes a chute adapted to compensate for varying vertical distance between said first higher and said second lower positions, said chute comprising:

a succession of linked, rigid and spaced apart shaping sections, said shaping sections each having at least one ring-like structure, said succession including a number of shaping sections being connected by elastic cords attached to the shaping sections in positions along circumferences of the ring-like structures, said elastic cords linking successive shaping sections and being arranged to allow relative motion substantially in a direction corresponding to a longitudinal axis of the succession of shaping sections, and

at least one tunnel-like device arranged and held inside the succession of shaping sections, said tunnel-like device being adapted to enable a person who is being evacuated to move from said first position to said second position through the tunnel-like device,

and wherein the elastic cords include cords, which are extending in a course of direction which is progressing differently from vertically when the escape system has been launched and the chute is hanging vertically from the higher position to the lower position, such that tension is applied to the elastic cords.

Improved compensation for varying evacuation height could be obtained by using elastic cords allowing higher strain and thereby longer elongation. Higher strain means higher stress, which indicate risk of rupture and is therefore not considered. A longer chute may allow longer maximum length, but on the other hand also longer minimum length, and hence is not a solution. By the present invention it is realised that a longer elongation of the chute may be obtained without increasing the minimum length when the elastic cords are extending in any course of direction which is progressing differently from vertical, when the escape system has been launched and the chute is hanging vertically. When the cords extend in a course of direction differently from a vertical course of direction, the extent of the cords between the shaping sections is thereby longer without the distance between the shaping sections becoming longer. A linear connection with a course of direction which is vertical, i.e. parallel to the longitudinal axis of the succession of shaping sections corresponds to a linear connection between two points, which is the shortest possible connection. Any course of direction which is other than parallel to the longitudinal axis is longer than such a connection. Since any elastic cord has a maximum strain which it may safely endure, a longer extent of such a cord subjected to maximum strain will result in a longer elongation, and hence longer maximum length while maintaining or even reducing minimum length. One effect is therefore that the ability of the escape system to compensate for varying evacuation height is improved.

Elastic cords extending in a course of direction progressing differently from a vertical course of direction may be provided by guiding the cords along sections of a circumference of a ring-like structure in a manner, where the elastic cords may be stretched in a direction of the circumference of the ring-like structure. The cords are hereby progressing in a course of direction between successive ring-like structures which is longer than the distance between the ring-like structures. This enhances the elasticity of the chute. The cords may e.g. be guided by pulleys or eyelets attached to the ring-like structure.

Longer cords may also be obtained in an embodiment involving an escape system for emergency evacuation from a first higher position to a second lower position, where the escape system includes a chute adapted to compensate for varying vertical distance between said first higher and said second lower positions, said chute comprising:

a succession of linked, rigid and spaced apart shaping sections, said shaping sections each having at least one ring-like structure, said succession including a number of shaping sections being connected by elastic cords attached to the shaping sections in positions along circumferences of the ring-like structures, said elastic cords linking successive shaping sections and being arranged to allow relative motion substantially in a direction corresponding to a longitudinal axis of the succession of shaping sections, and

at least one tunnel-like device arranged and held inside the succession of the shaping sections, said tunnel-like device being adapted to enable a person, who is being evacuated, to move from said first position to said second position through the tunnel-like device,

and where the elastic cords include cords which are extending between successive shaping sections in a course of direction which is progressing differently from vertically when the escape system has been launched and the chute is hanging vertically from the higher position to the lower position, such that tension is applied to the elastic cords. The desired effect is obtained whenever the cords are arranged with a course of direction which is longer than the straight vertical course of direction.

Longer cords may further be obtained when the cords in at least one plane, said plane being parallel to the longitudinal axis of the succession of shaping sections, are extending in a course of direction progressing differently from a linear course of direction which is parallel to the longitudinal axis of the succession of shaping sections, when the escape system has been launched and the chute is hanging from the higher position to the lower position, such that tension is applied to the elastic cords.

Elastic cords extending in a course of direction progressing differently from a vertical course of direction may be provided in a number of ways. In one embodiment of the escape system, elastic cords may be included which at least in sections are arranged with a linear course of direction. Another embodiment involves that elastic cords are included which are arranged in sections, said sections having different linear courses of direction. This may be arranged as a zigzagging course of direction. In a further embodiment the sections of elastic cord may be arranged with an angle of at least 15 degrees relative to the longitudinal axis of the succession of shaping sections. In fact, the larger the angle the longer the cords will typically be.

To obtain a non-parallel course of direction of the elastic cords relative to the longitudinal axis of the succession of shaping sections, one embodiment of the system may include elastic cords which at least are connected two-by-two with a lashing or a rigid connector, said connector providing a coupling between at least two elastic cords, preferably substantially midway between two shaping sections. When the cords are connected, each cord is forced away from its natural course of direction into a more curved or bent course of direction. This will shorten the distance between the shaping sections, whereby longer cords may be used while maintaining a certain preferred distance. Also, elastic cords may be included which are interconnected two-by-two with one or more resilient connectors, said connectors allowing two cords to be increasingly separated under increased tension in the cords. This provides a possibility of increasing the elongation of the chute, because the cords may change their course of direction when tensioned, i.e. be more softly curved or bent.

In another embodiment elastic cords may be included where elastic cords two-by-two are attached to one shaping section in two separate positions at a distance which is different from two positions where the two cords are separately attached to a successive shaping section. The cords will hereby in pairs form a relatively acute or obtuse angle. In another embodiment elastic cords may be included which are arranged to cross each other in at least one position in their respective courses of direction between one shaping section and a successive shaping section, or even be arranged in a net-like pattern.

A further embodiment of the invention involves that the chute includes a plurality of parallel and connected chute sections, each chute section being adapted to allow escape from the higher position to the lower position. This may include that the chute is a twin, triple or quadruple chute. In case of a twin-chute, such a chute may include two stocking-like devices, and the shaping sections have two connected ring-like structures, preferably being shaped and arranged in a figure-of-eight-like manner. Such a twin-chute may double the evacuation capacity of the system, since two persons may simultaneously escape via each of the two stocking-like devices. Also, multiple or plural chute sections provide redundancy such that in case one chute section becomes blocked or fails, then other chute sections may still be functioning, whereby safety is increased. Preferably the system is adapted for maritime use and includes at least one rescue vessel, survival craft, life raft or a platform, which is adapted for being positioned floating at the second lower position. This may involve that the system is adapted for being launched from a sailing vessel, preferably a passenger liner, a ferry, a cargo vessel or a cruise liner, or an oil rig. The problem of varying distance from the higher position to the lower position is of course common at sea, but may also exist in other environments where the system according to the invention may be used.

### BRIEF DESCRIPTION OF THE FIGURES

FIG. 1 shows a perspective view of an escape system according to the invention in use under maritime conditions, where people are evacuated from a passenger liner to a floating platform,

FIG. 2 shows a longitudinal, cross-sectional view of a chute,

FIG. 3 shows a perspective view of shaping sections linked with elastic cords,

FIGS. 4a & 4b show views of shaping sections linked with elastic cords: crossed two-by-two,

FIGS. 5-12 show examples of courses of direction in which elastic cords may be lead between successive shaping sections.

### DETAILED DESCRIPTION OF THE FIGURES

The figures show simplified, exemplary features and functionalities of an escape system according to the invention. The figures are merely included as information given as examples to a skilled person of how the invention may be carried out.

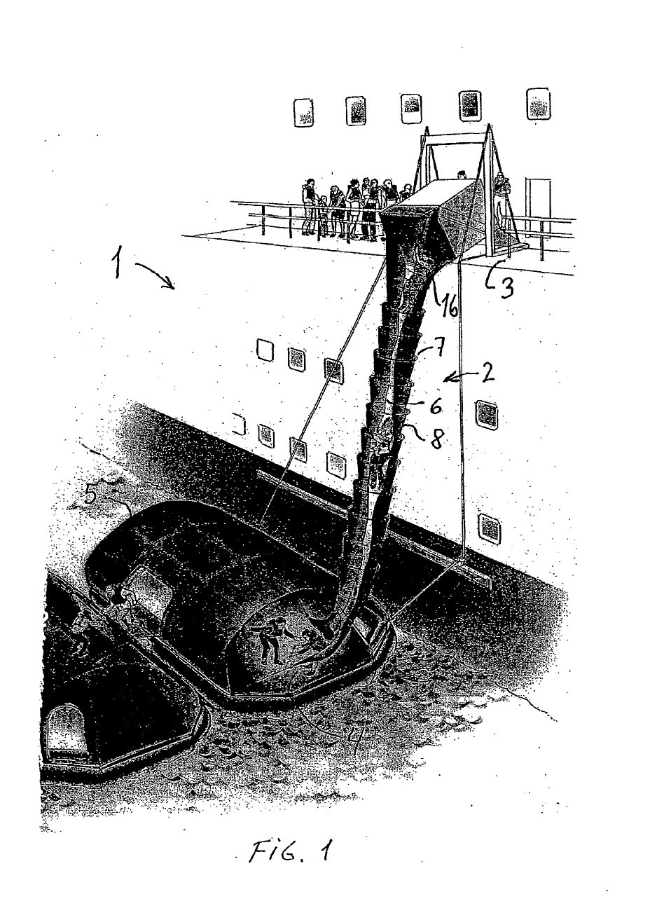

FIG. 1 shows an escape system 1 according to the invention. The system 1 has been launched from a passenger liner for emergency evacuation from a first higher position 3 to a second lower position 4 where a floating platform 5 is placed. The escape system 1 includes a chute 2 adapted to compensate for varying vertical distance between the first higher and the second lower positions 3, 4. The chute 2 is preferably anchored to the floating platform 5. The chute 2 has a succession of linked, rigid and spaced apart shaping sections 7. The shaping sections each have a ring-like structure which may be circular or C-shaped, but may also be oval, triangular, rectangular, polygonal or any shape which forms a type of enclosure and which is smooth and rounded with no sharp corners. The shaping sections 7 are connected by elastic cords (not shown) which are attached to circumference of the shaping sections 7 for linking the successive shaping sections 7 in a way which allows relative motion substantially in a direction corresponding to a longitudinal axis of the succession of shaping sections 7. The longitudinal axis of the succession of shaping sections 7 corresponds to a longitudinal axis of the chute 2. An elastic stocking-like device 6 is arranged and held inside the succession of shaping sections 7. The stocking-like device 6 is adapted to slow a rate of descent of a falling person who is being evacuated from the first higher position 3 to the second lower position 4 through the stocking-like device 6. Instead of the stocking-like device other devices may be used, which may aid a person to descent safely inside the chute 2. At the upper end of the chute 2 is a person 16 entering the stocking-like device 6 in order to slide downwards through the stocking-like device 6 to the floating platform 5. To protect and guide the stocking-like device 6 there is provided a number of funnels 8, each of which are attached to a shaping section 7 in one end.

FIG. 2 shows a chute 2 including a succession of shaping sections 7 having funnels 8 extending inwards conically to guide a stocking-like device 6 made from a number of successive stocking-like sections which are each placed and held inside the shaping sections 7. The stocking-like device 6 may be manufactured using a non-abrasive Kevlar™ net or fabric. In one embodiment the stocking-like device 6 is attached to each shaping section 7. The funnels 8 may be made of a woven or a non-woven textile. A longitudinal axis 18 of the succession of shaping sections is shown. The longitudinal axis 18 corresponds to a longitudinal axis of the chute 2. The chute 2 may externally be provided with a chute protector 10, such as an elastic, tubular tarpaulin as displayed in FIG. 2. The chute protector 10 may alternatively be made from a knitted jersey fabric. In order to facilitate entry into the stocking-like device 6, a plastic lining, e.g. made of polyvinyl chloride (PVC), may be provided at the entrance.

FIG. 3 shows shaping sections 7 connected by elastic cords 9. The elastic cords 9 are in pairs two-by-two connected by a resilient connector 12. The depicted shaping sections 7 are generally rectangular in shape with rounded corners. The shape of the ring-like shaping sections 7 may be round or triangular, rectangular or polygonal with rounded corners, or oval, and has a minimum diameter or transversal size of 0.7 meters. The longitudinal axis 18 which corresponds to the one shown in FIG. 2, but which is not shown in FIG. 3, extends longitudinally to the succession of four shaping sections 7. A first plane containing two connected elastic cords 9 is parallel to the longitudinal axis of the succession of shaping sections 7, but in a second plane which is perpendicular to such a first plane, and which is parallel to the longitudinal axis, the cords 9 extend in a course of direction progressing differently from a linear course of direction which is parallel to the longitudinal axis of the succession of shaping sections 7. The primary object is to lead the cords 9 in courses of directions which substantially longer than a straight, linear vertical path. This is in a situation such as in FIG. 3 which corresponds to when the escape system 1 has been launched and the chute 2 is hanging from the higher position 3 to the lower position 4, such that tension is applied to the elastic cords 9 as displayed in FIG. 1. The elastic cords 9 are individual sections which each link two shaping sections 7 and are attached to the shaping sections 7 by a lashing 14. Four cords 9 link two successive shaping sections 7, but also six, eight or more elastic cords may be used for linking two successive shaping sections 7. The elastic cords 9 may of course instead be arranged in individual cord sections which each are connecting multiple, successive shaping sections 7. In such case the cords 9 may be connected to the shaping sections 7 by lashings 14 and/or brackets. The elastic cords 9 preferably have an elasticity where a force in the range from 100 to 600 N is required to obtain a 50% strain, which means that it takes 100 to 600 N to stretch a cord with an unstretched length of 1.0 meter to a length of 1.5 meters. The shaping sections 7 are preferably rings made of metal, preferably stainless steel, or a polymeric material, wood, or a composite material containing fibres. The shaping sections 7 may have ring-like shapes. In FIGS. 2 and 3 the successive shaping sections 7 are connected with elastic cords 9 having substantially equal lengths. When manufactured the shaping sections 7 are connected to elastic cords 9 at substantially equal distances. The chute 2 may also have successive shaping sections 7, which are connected with elastic cords having dissimilar length in the succession of shaping sections 7, preferably having a shorter length near the first higher position 3.

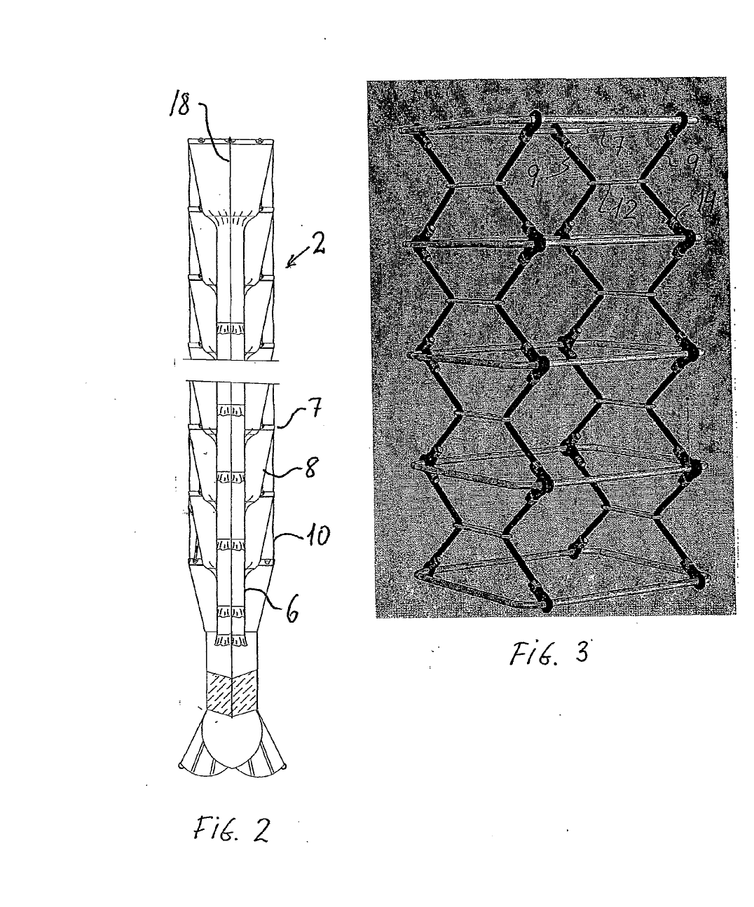

FIGS. 4a and 4b show a succession of four shaping sections 7 connected by elastic cords 9. The shaping sections are round. Eight cords connect two successive shaping sections 7 where the cords 9 two-by-two cross each other, whereby the cords 9 are longer than if the cords 9 were arranged in a straight course of direction from section 7 to section 7, which would be a linear course parallel to the longitudinal axis of the succession of shaping sections 7.

FIGS. 5 and 6 show shaping sections 7 connected by elastic cords 9. In FIG. 5 the cords 9 are attached with a distance a1 to one shaping section 7 and with a different distance a2 to a successive shaping section 7. The distance from shaping section 7 to shaping section 7 in the succession of sections 7 is denoted d. The distance d between two successive shaping sections may be in a range from 0.3 meters to 1.5 meters, preferably between 0.4 meters and 1 meter, when the chute 2 is hanging freely from the first higher position 3 and is substantially unstretched towards the second lower position 4.

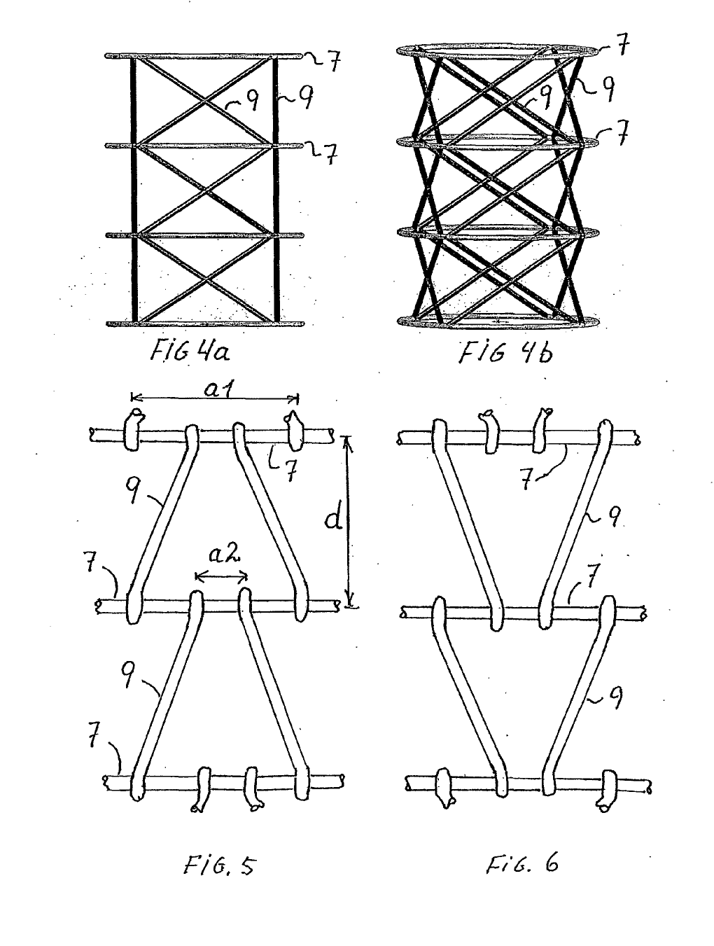

FIGS. 7-12 show various examples of ways to arrange elastic cords 9 between shaping sections 7. It is not shown how the cords 9 are connected to the shaping sections 7, but this may be done with lashings, brackets or other suitable means. In FIG. 7 a resilient connector 12 is connecting the cords 9 midway between the shaping sections 7. In FIG. 8 the connector 12 is rigid. In FIG. 9 the cords 9 are crossing and may be connected where they cross with a lashing or bracket, but may also not be connected. In FIG. 11 the cords 9 are crossing and are arranged in a net-like pattern. Also here the cords 9 may be connected. In

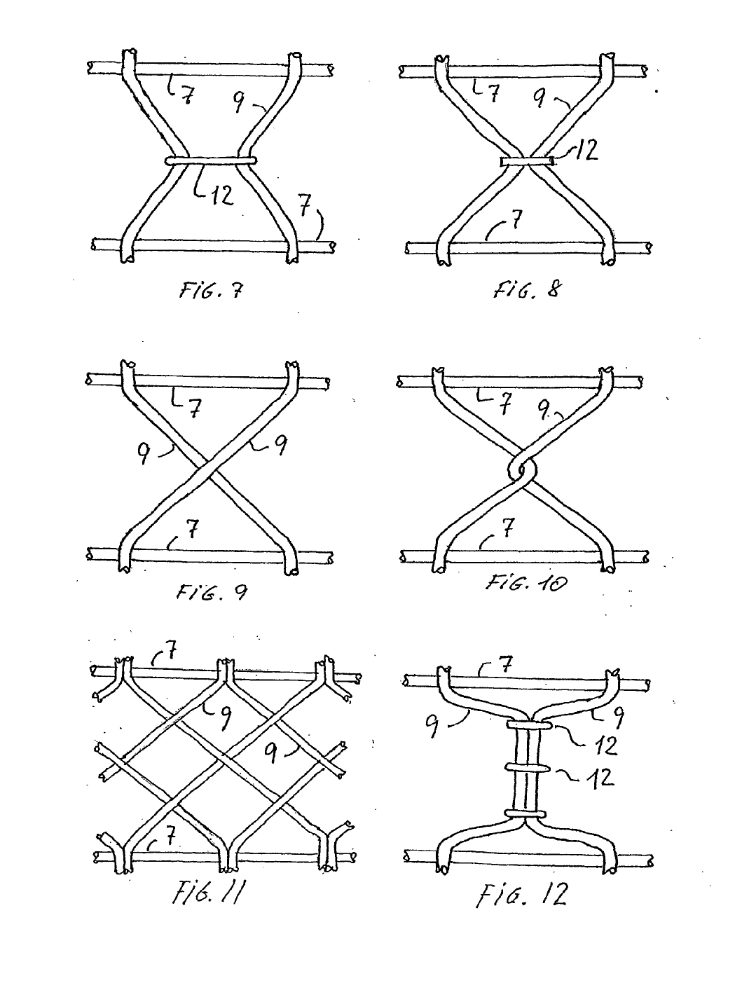

FIG. 10 the cords 9 are twisted to obtain a crossing effect without a lashing or bracket. In FIG. 12 three resilient connectors 12 connect the cords 9. It is to be understood that the invention as disclosed in the description and in the figures may be modified and changed and still be within the scope of the invention as claimed hereinafter.

1. An escape system for emergency evacuation from a first higher position to a second lower position, where the escape system includes a chute adapted to compensate for varying vertical distance between said first higher and said second lower positions, said chute comprising:
a succession of linked, rigid and spaced apart shaping sections, said shaping sections each having at least one ring-like structure, said succession including a number of shaping sections being connected by elastic cords attached to the shaping sections in positions along circumferences of the ring-like structures, said elastic cords linking successive shaping sections and being arranged to allow relative motion substantially in a direction corresponding to a longitudinal axis of the succession of shaping sections, and
at least one tunnel-like device arranged and held inside the succession of the shaping sections, said tunnel-like device being adapted to enable a person, who is being evacuated, to move from said first position to said second position through the tunnel-like device,
and wherein the elastic cords include cords which are extending in a course of direction which is progressing differently from vertically when the escape system has been launched and the chute is hanging vertically from the higher position to the lower position, such that tension is applied to the elastic cords.

2. An escape system according to claim 1, wherein elastic cords are included which are guided along sections of a circumference of a ring-like structure in a manner where the elastic cords may be stretched in a direction of the circumference of the ring-like structure.

3. An escape system according to claim 1, wherein the elastic cords include cords which are extending between successive shaping sections in a course of direction which is progressing differently from vertically when the escape system has been launched and the chute is hanging vertically from the higher position to the lower position, such that tension is applied to the elastic cords.

4. An escape system according to claim 1, wherein elastic cords are included which, at least in sections, are arranged with a linear course of direction.

5. An escape system according to claim 1, wherein elastic cords are included, which are arranged in sections, said sections having different linear courses of direction.

6. An escape system according to claim 1, wherein sections of elastic cord are arranged in an angle of at least 15 degrees relative to the longitudinal axis of the succession of shaping sections.

7. An escape system according to claim 1, wherein elastic cords are included which at least are connected two-by-two with a lashing or a rigid connector, said connector providing a coupling between the at least two elastic cords, preferably substantially midway between two shaping sections.

8. An escape system according to claim 1, wherein elastic cords are included, which are interconnected at least two-by-two with one or more resilient connectors, said connectors allowing at least two cords to be increasingly separated under increased tension in the cords.

9. An escape system according to claim 1, wherein elastic cords are included which are attached two-by-two to one shaping section in two separate positions at a distance which is different from two positions where the two cords are separately attached to a successive shaping section.

10. An escape system according to claim 1, wherein elastic cords are included which are arranged to cross each other in at least one position in their respective course of directions between one shaping section and a successive shaping section.

11. An escape system according to claim 1, wherein elastic cords are included, which are arranged in a net-like pattern in their respective courses of direction between two successive shaping sections.

12. An escape system according to claim 1, wherein at least four, preferably at least six, and especially at least eight elastic cords are linking two successive shaping sections.

13. An escape system according to claim 1, wherein elastic cords are included, said cords having individual cord sections each connecting one shaping section to a successive shaping section.

14. An escape system according to claim 1, wherein elastic cords are included, said cords connecting multiple, successive shaping sections.

15. An escape system according to claim 1, wherein elastic cords are connected to the shaping sections by lashings and/or brackets.

16. An escape system according to claim 1, wherein a number of shaping sections each include a ring made of a metal, preferably stainless steel, a polymeric material, wood, or a composite material containing fibres.

17. An escape system according to claim 1, wherein the tunnel-like device comprises at least one elastic stocking-like device arranged and held inside the succession of shaping sections, said stocking-like device being adapted to slow a rate of descent of a falling person who is being evacuated from said first position to said second position through the stocking-like device.

18. An escape system according to claim 17, wherein the stocking-like device includes a plurality of successive stocking-like sections each being connected to a shaping section.

19. An escape system according to claim 1, wherein a number of woven or non-woven textile funnels are included, said funnels being connected to the shaping sections.

20. An escape system according to claim 1, wherein a number of successive shaping sections are included, which are connected with elastic cords having substantially equal lengths or which when manufactured are connected to elastic cords at substantially equal distances.

21. An escape system according to claim 1, wherein successive shaping sections are included, which are connected with elastic cords having dissimilar lengths in the succession of shaping sections, preferably having a shorter length near the first higher position, or which when manufactured are connected to elastic cords at dissimilar distances.

22. An escape system according to claim 1, wherein successive shaping sections are included, where the distance between two successive shaping sections is in a range from 0.3 meters to 1.5 meters, preferably between 0.4 meters and 1 meter, when the chute is hanging freely from the first higher position and is substantially unstretched towards the second lower position.

23. An escape system according to claim 1, wherein the shape of the ring-like shaping sections is round, oval, triangular, rectangular or any other polygonal shape and preferably provided with rounded corners, and has a minimum diameter or transversal size of 0.7 meters.

24. An escape system according to claim 1, wherein the elastic cords include cords having an elasticity where a force in a range from 100 to 600 N is required to obtain a 50% strain.

25. An escape system according to claim 1, wherein the chute includes a plurality of parallel and connected chute sections, each chute section being adapted to allow escape from the higher position to the lower position.

26. An escape system according to claim 25, wherein the chute is a twin, triple or quadruple chute.

27. An escape system according to claim 1, wherein the system is adapted for maritime use and includes at least one rescue vessel, survival craft, life raft or platform adapted for being positioned floating at the second lower position.

28. An escape system according to claim 1, wherein the system is adapted for being launched from a sailing vessel, preferably a passenger liner, a ferry, a cargo vessel or a cruise liner, or an oil rig.
